(19) United States
(12) Patent Application Publication
(10) Pub. No.: US 2023/0182571 A1
(43) Pub. Date: Jun. 15, 2023

(54) DISPLAY METHOD FOR VEHICLE, DISPLAY SYSTEM FOR VEHICLE, AND VEHICLE

(71) Applicant: FAURECIA CLARION ELECTRONICS EUROPE, PARIS (FR)

(72) Inventors: Mohamed MEKOUAR, Paris (FR); Julien RICHEFEU, Paris (FR); Steve CHADAUD, Paris (FR); Sonia POUHAER, Paris (FR)

(21) Appl. No.: 18/078,408

(22) Filed: Dec. 9, 2022

(30) Foreign Application Priority Data
Dec. 9, 2021 (FR) FR 2113200

(51) Int. Cl. B60K 35/00; G06F 3/0488

(52) U.S. Cl. CPC B60K 35/00; G06F 3/0488; B60K 2370/115; B60K 2370/119; B60K 2370/563; B60K 2370/573; B60K 2370/586

(57) ABSTRACT

A display method implemented using a display system for a vehicle, the method including the following steps: connecting said mobile terminal to the onboard display device; displaying, on the screen of the onboard display device, a graphical user interface comprising a first menu representing said plurality of applications as icons; generating a graphical user interface on the touch screen of the mobile terminal; and using the touch screen of the mobile terminal as a touchpad to navigate the first menu of the graphical user interface displayed on the screen of the onboard display device, a swiping gesture by a user's finger on the touch screen of the mobile terminal generating the display of movement of a marking area in the first menu of the graphical user interface displayed on the screen of the onboard display device, the marking area indicating the selection of an icon.

### TECHNICAL FIELD

The present invention relates to a display method for a vehicle, a display system for a vehicle, and a vehicle comprising such a display system.

### BACKGROUND

Various solutions exist for navigating the menu of an onboard display device, for example such as using buttons arranged on the steering wheel or on the central console or selecting an application by contact with the touch screen of the onboard display device. These solutions are not very user-friendly when driving, because the driver's arm is usually not long enough to easily touch the screen of the onboard display device or the buttons on the center console, and only a small number of buttons can be arranged on the steering wheel.

### SUMMARY

An aim of the present invention is to provide a system which facilitates navigating the menu of an onboard display device while reducing distractions when driving.

In accordance with an aspect of the present invention there is provided is a display method implemented using a display system for a vehicle, in particular for a motor vehicle, the display system comprising an onboard display device and a mobile terminal; the onboard display device comprising a screen configured to display data, a processing unit, a storage memory, and a communication interface, the mobile terminal comprising a touch screen, a processing unit, a memory storing a plurality of applications, and a communication interface, said mobile terminal being suitable for connecting to the onboard display device in order to project at least one application on the screen of the display device, the method comprising the following steps:
connecting said mobile terminal to the onboard display device via the communication interface of the onboard display device and the communication interface of the mobile terminal,
displaying said plurality of applications on the screen of the onboard display device, by generating a graphical user interface comprising a first menu representing said plurality of applications represented by icons,
generating a graphical user interface on the touch screen of the mobile terminal, and
using the touch screen of the mobile terminal as a touchpad to navigate the menu of the graphical user interface, displayed on the screen of the onboard display device, a swiping gesture with at least one finger of a user on the touch screen of the mobile terminal generating the displaying of movement of a marking area in the first menu of the graphical user interface displayed on the screen of the onboard display device, said marking area indicating the selection of an icon.

The features set forth in the following paragraphs may optionally be implemented. They may be implemented independently of each other or in combination with each other:
The swiping gesture on the touch screen is one among a right-to-left motion, left-to-right motion, top-to-bottom motion, and bottom-to-top motion.
The speed of movement of the marking area is proportional to the speed of the swiping gesture of the user's finger on the touch screen of the mobile terminal.
The method comprises the following steps:
   selecting an icon among several icons displayed on the screen of the onboard display device, by means of a finger gesture on the touch screen of the mobile terminal, each icon respectively corresponding to one of the applications;
   confirming said selection of said icon by an action on the touch screen of the mobile terminal;
   executing, on the mobile terminal, the selected and confirmed application; and
   displaying the executed application on the screen of the onboard display device.
The graphical user interface comprises a second menu, the first menu comprising a first return icon which allows displaying the second menu, and the second menu comprising a second return icon which allows returning to displaying the first menu.
The graphical user interface comprises a first zone for displaying the first menu and a second zone for displaying an executed application, said first zone being different from said second zone.
The graphical user interface generated on the touch screen of the mobile terminal is an image showing a uniform color, preferably a black color.
The graphical user interface generated on the touch screen of the mobile terminal is an image showing arrows pointing in different directions.
The touch screen of the mobile terminal has a defined brightness before the step of generating the graphical user interface, and the step of generating a graphical user interface on the touch screen of the mobile terminal comprises a step of decreasing the brightness of the touch screen of the mobile terminal by at least 20% compared to the defined brightness before the step of generating the graphical user interface.

The invention also relates to a display system for a vehicle, in particular for a motor vehicle, the display system comprising:
an onboard display device comprising a screen configured to display data, a processing unit, a memory storing at least one display application adapted to display data, and a communication interface,
the mobile terminal, comprising a touch screen, a processing unit, a memory storing a plurality of applications, and a communication interface, said mobile terminal being suitable for connecting to the onboard display device in order to project at least one application on the screen of the display device,
characterized in that the onboard display device is able to generate and display a graphical user interface comprising a first menu representing said plurality of applications by icons, the mobile terminal being capable of generating a graphical user interface on the touch screen; the touch screen of the mobile terminal being used as a touchpad for navigating the first menu of the graphical user interface, displayed on the screen of the onboard display device, and a swiping gesture of at least one finger of a user on the touch screen of the mobile terminal generates movement of a marking area in the first menu of the graphical user interface displayed on the screen of the onboard display device, said marking area indicating the selection of an icon.

Finally, an object of the invention is a vehicle comprising a display system in accordance with the features mentioned above, the vehicle further comprising a support suitable for carrying the mobile terminal.

### BRIEF DESCRIPTION OF THE DRAWINGS

FIG. 1 is a diagram representing a display system according to an embodiment of the invention;

FIG. 2 is a diagram representing a flowchart of the steps of the display method according to an embodiment of the invention;

FIG. 3 is a diagram representing an example of a first menu of a graphical user interface displayed on the screen of the onboard display device; and

FIG. 4 is a diagram representing an example of a second menu of a graphical user interface displayed on the screen of the onboard display device.

### DETAILED DESCRIPTION

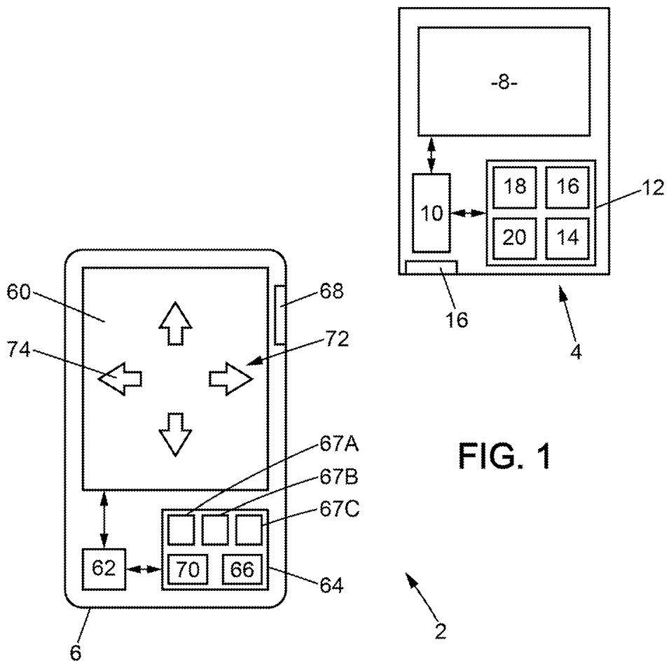

Referring to FIG. 1, the display system 2 according to an embodiment of the invention comprises a display device 4 intended to be carried on board a vehicle, and a mobile terminal 6.

The onboard display device 4 comprises a screen 8 configured to display data, a processing unit 10, a memory 12 storing at least one display application 14, and a communication interface 16 suitable for communicating with the mobile terminal 6.

The screen 8 of the onboard display device is for example a plasma screen or a liquid crystal screen. The screen 8 of the onboard display device may or may not be touch-sensitive.

The processing unit 10 of the onboard display device consists of a processor or a microprocessor. It may for example consist of the central processing unit of the vehicle (generally called the “ECU”) or an independent processor.

The memory 12 of the onboard display device comprises a random access memory (RAM) and a read-only memory (ROM). The memory 12 is suitable for storing programs for implementing the display method according to the invention. In particular, the memory stores the display application 14 described below and possibly other infotainment applications 18, 20. The display application is capable of running with the remote control application 66 stored in a memory of the mobile terminal. The display application 14 is adapted to display a graphical user interface 22 comprising at least a first menu 24 representing icons 26.

The communication interface 16 may be a wired interface comprising, for example, a USB port. It is also possible for the communication interface 16 to be wireless. The Wifi protocol or Bluetooth protocol may for example be used.

The mobile terminal 6 is preferably a mobile smart phone in which a remote control application 66 has been implemented. The mobile terminal 6 belongs to a driver or passenger of the vehicle.

The mobile terminal 6 may be arranged on a specific support placed between the steering wheel and the screen of the onboard display device. Alternatively, the support may be located between the front seats and rear seats.

The mobile terminal 6 comprises a touch screen 60, a processing unit 62, a memory 64 storing at least one remote control application 66, and a communication interface 68 configured to communicate with the communication interface 16 of the onboard display device, and a SIM, USIM, or microSIM card.

The mobile terminal 6 may be connected to a communication network via a wireless access network, such as a GSM, UMTS, 3G, 4G, 5G, or other mobile network.

The processing unit 62 of the mobile terminal consists of a processor or a microprocessor.

The memory 64 of the mobile terminal comprises a random access memory (RAM) and a read-only memory (ROM). The memory is suitable for storing the remote control application 66 for implementing the display method, and/or infotainment applications 70.

The communication interface 68 of the mobile terminal, for communicating with the onboard display device, is compatible with the communication interface 16 of the onboard display device. Communication interface 68 may be wired or wireless.

The display system 2 may also comprise one or more control buttons mounted on the dashboard or on the steering wheel. These control buttons have not been represented.

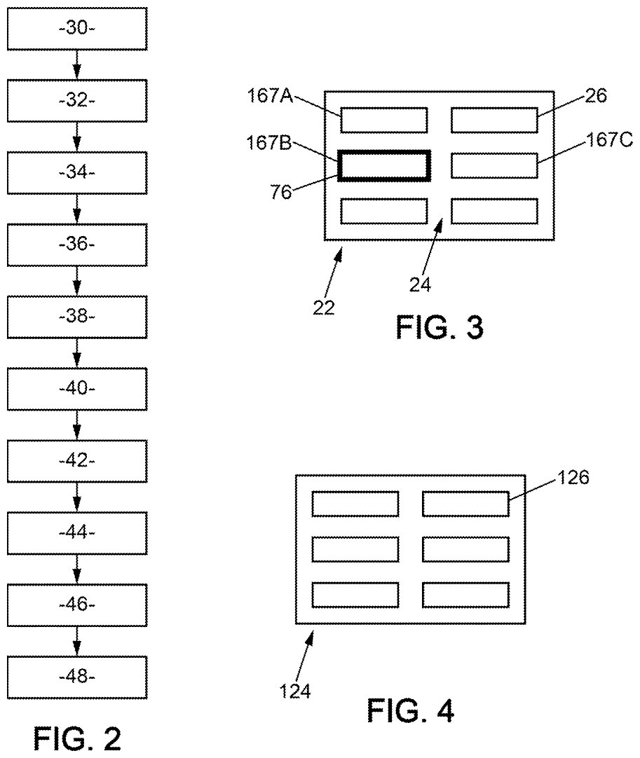

Referring to FIG. 2, the display method according to the invention begins with a step 30 of establishing a communication link between the mobile terminal 6 and the onboard display device 4. This connection is for example a wired connection.

During a step 32, the graphical user interface 22 comprising the first menu 24 showing icons 167A, 167B, 167C, 26 is displayed on the screen 8 of the onboard display device.

An example of a graphical user interface is represented in FIG. 3. This graphical user interface 22 shows a first menu 24 comprising two lists of icons arranged one on the right and the other on the left of the screen. Each list contains several icons 167A, 167B, 167C, 26 extending from the top to the bottom of the screen.

During a step 34, the remote control application 66 is launched by the user. This application may be launched by selecting it using the touch screen 60 of the mobile terminal or by selecting it using a control button or by pressing on the screen 8 of the onboard display device when said device is a touch device.

During a step 36, a graphical user interface 72 is generated on the touch screen of the mobile terminal. According to a first embodiment, the graphical user interface 72 consists, for example, of an image showing arrows 74 pointing in different directions. For example, this graphical user interface may show an arrow pointing up, an arrow pointing down, an arrow pointing left, and an arrow pointing right. An example of such a graphical user interface is shown in FIG. 1.

According to a second embodiment, the graphical user interface 72 generated on the touch screen 60 of the mobile terminal is an image showing a uniform color, preferably a black color.

According to a third embodiment, the generation of a graphical user interface comprises a step of decreasing the brightness of the touch screen of the mobile terminal by at least 20% compared to the brightness defined before the step of launching the remote control application.

During a step 38, the user uses the touch screen 60 of the mobile terminal as a touch pad to navigate the first menu 24 of the graphical user interface displayed on the screen 8 of the onboard display device. During this step, a swiping gesture by a finger of the user on the touch screen 60 of the mobile terminal in a direction of the arrows 74 moves a marking area 76 in the first menu of the graphical user interface. The marking area is a type of pointing device comprising, for example, a brighter area, a highlighted area or a frame surrounding the selected icon.

The swiping gesture on the touch screen is made in a direction of the arrows 74. This gesture may thus be made from right to left, from left to right, from top to bottom, or from bottom to top. For example, if the mobile terminal is arranged substantially vertically, when the finger moves downwards, the marking area 76 moves downwards from one icon to next, or if the mobile terminal is arranged substantially horizontally, when the finger moves rearwards, the marking area 76 moves downwards from one icon to the next. When the finger moves to the right, the marking area 76 moves to the right to the list of icons arranged to the right of the screen of the onboard display device. Preferably, the speed of the marking area 76 is proportional to the speed of the swiping gesture of the user's finger on the touch screen of the mobile terminal. Consequently, the number of icons traversed by the marking area is proportional to the speed of the swiping gesture of the user's finger on the touch screen of the mobile terminal. During a step 40, an icon 167A displayed on the screen 8 of the onboard display device is selected by motion of a finger on the touch screen 60 of the mobile terminal. This icon 167A represents an application, for example an infotainment application, and/or a command such as a command to view another menu for example.

During a step 42, the user confirms the selection by performing an action on the touch screen 60 of the mobile terminal, for example a tap or a double tap. Following this action, a display command is transmitted from the mobile terminal to the onboard display device during a step 44.

In a variant, during a step 46, the selected and confirmed application 67A is executed on the mobile terminal.

During a step 48, the executed application is displayed on the screen (8) of the onboard display device 4.

According to another example, if an application represented by an icon in the menu has been selected and confirmed, the corresponding application is launched. The infotainment applications 18, 20 stored in the memory 12 of the display device, the infotainment applications 70 stored in the memory of the mobile terminal 6, or applications stored in a server on the Internet and received by the mobile terminal, can thus be displayed on the screen 8 of the display device.

Alternatively, the graphical user interface 22 is modified according to the display command received by the display device following step 44. For example, if a first menu 24 was displayed during steps 32 to 44, and the user selects a first return icon 26, a second menu 122 is displayed during a following step on the screen 8 of the onboard display device, instead of the first menu. This second menu 122 is illustrated in FIG. 4. The second menu 122 contains other icons representative of other infotainment applications.

Advantageously, the second menu 122 includes a second return icon 126 which allows returning to the first menu.

Alternatively, the graphical user interface has only one menu.

According to a variant not shown, the graphical user interface 22 comprises a first zone for displaying the first menu and a second zone for displaying an executed application. The first zone is different from the second zone.

The display method according to the invention thus makes it possible to easily transmit applications from a mobile terminal to the onboard display device of the vehicle. Above all, due to using the mobile terminal's touch screen as a touchpad for navigating the menu of the graphical user interface displayed on the screen of the onboard display device, navigation in this menu can be achieved by swiping a finger on the touch screen of the mobile terminal, and the user experience is thus improved.

The invention also relates to a vehicle comprising a support suitable for carrying the mobile terminal. The support is advantageously arranged between the steering wheel and the screen of the onboard display device or between the front seats and rear seats of the vehicle.

1. A display method implemented using a display system for a vehicle, the display system comprising an onboard display device and a mobile terminal, the onboard display device comprising a screen configured to display data, a processing unit, a storage memory, and a communication interface, the mobile terminal comprising a touch screen, a processing unit, a memory storing a plurality of applications, and a communication interface, said mobile terminal being suitable for connecting to the onboard display device in order to project at least one application on the screen of the display device, the method comprising the following steps:
connecting said mobile terminal to the onboard display device via the communication interface of the mobile terminal and the communication interface of the onboard display device;
displaying said plurality of applications on the screen of the onboard display device, by generating a graphical user interface comprising a first menu representing said plurality of applications as icons;
generating a graphical user interface on the touch screen of the mobile terminal; and
in response to a swiping gesture from at least one finger of a user on the touch screen of the mobile terminal, generating on the screen of the onboard display an indication of movement of a marking area in the first menu of the graphical user interface, said marking area indicating the selection of an icon.

2. The display method according to claim 1, wherein the swiping gesture on the touch screen is one among a right-to-left motion, left-to-right motion, top-to-bottom motion, and bottom-to-top motion.

3. The display method according to claim 1, wherein the speed of movement of the marking area is proportional to the speed of the swiping gesture of the user's finger on the touch screen of the mobile terminal.

4. The display method according to claim 1, comprising the following steps:
receiving the selection of an icon among several icons displayed on the screen of the onboard display device, via a finger gesture on the touch screen of the mobile terminal, each icon respectively corresponding to one of the applications;
confirming said selection of said icon by an action on the touch screen of the mobile terminal;
executing, on the mobile terminal, the selected and confirmed application; and
displaying the executed application on the screen of the onboard display device.

5. The display method according to claim 1, wherein the graphical user interface comprises a second menu, the first menu comprising a first return icon which allows displaying the second menu, and the second menu comprising a second return icon which allows returning to displaying the first menu.

6. The display method according to claim 1, wherein the graphical user interface comprises a first zone for displaying the first menu and a second zone for displaying an executed application, said first zone being different from said second zone.

7. The display method according to claim 1 wherein the graphical user interface generated on the touch screen of the mobile terminal is an image showing a uniform color.

8. The display method according to claim 1, wherein the graphical user interface generated on the touch screen of the mobile terminal is an image showing arrows pointing in different directions.

9. The display method according to claim 1, wherein the touch screen of the mobile terminal has a defined brightness before the step of generating the graphical user interface; and wherein the step of generating a graphical user interface on the touch screen of the mobile terminal comprises a step of decreasing the brightness of the touch screen of the mobile terminal by at least 20% compared to the defined brightness before the step of generating the graphical user interface.

10. A display system for a vehicle, the display system comprising:
an onboard display device comprising a screen configured to display data, a processing unit, a memory storing at least one display application adapted to display data, and a communication interface; and
a mobile terminal, comprising a touch screen, a processing unit, a memory storing a plurality of applications, and a communication interface, said mobile terminal being suitable for connecting to the onboard display device in order to project at least one application on the screen of the display device;
wherein the onboard display device is able to generate and display a graphical user interface comprising a first menu representing said plurality of applications by icons, the mobile terminal being capable of generating a graphical user interface on the touch screen; the touch screen of the mobile terminal being usable as a touchpad for navigating the first menu of the graphical user interface displayed on the screen of the onboard display device, and wherein a swiping gesture of at least one finger of a user on the touch screen of the mobile terminal generates movement of a marking area in the first menu of the graphical user interface displayed on the screen of the onboard display device, said marking area indicating the selection of an icon.

11. A vehicle comprising the display system according to claim 10, the vehicle further comprising a support suitable for carrying the mobile terminal.

12. The display method accordingly to claim 7, wherein the uniform color is black.
